(19) United States
(12) Patent Application Publication
(10) Pub. No.: US 2013/0147680 A1
(43) Pub. Date: Jun. 13, 2013

(54) ANTENNA IMPEDANCE MATCHING METHOD

(71) Applicants: JIA-HUNG SU, New Taipei (TW); YI-FENG HUANG, New Taipei (TW); KAI SHIH, New Taipei (TW)

(72) Inventors: JIA-HUNG SU, New Taipei (TW); YI-FENG HUANG, New Taipei (TW); KAI SHIH, New Taipei (TW)

(73) Assignee: Cheng Uei Precision Industry Co., LTD., New Taipei City (TW)

(21) Appl. No.: 13/325,053

(22) Filed: Dec. 13, 2011

(51) Int. Cl. H01Q 1/50

(52) U.S. Cl. 343/861

(57) ABSTRACT

The present invention discloses an antenna impedance matching method which is used for adjusting an impedance of an antenna to match an impedance of a radio frequency (RF) integrated circuit (IC). The method comprises the following steps of: (1) providing an antenna matching IC; (2) obtaining a used frequency band of the RF IC, so as to obtain a frequency band signal; (3) adjusting an impedance of the matching IC according to the band signal, so that the antenna achieves impedance matching. In summary, the present invention uses the matching IC to instead of a traditional matching circuit, and according to the band signal of the RF IC to adjust and match the impedance of the IC, so as to change the resonance and impedance of the antenna, and to achieve the impedance matching.

### BACKGROUND OF THE INVENTION

1. Field of the Invention

The present invention relates to a field of communication equipment, and in particular to a method which can accurately adjust the antenna impedance to achieve the impedance matching.

2.The Related Arts

In a field of communication equipment, a Car-Load/Kit Radio Frequency (RF) is achieved by two technologies, one is that the RF engineers have to design a radio frequency (RF) integrated circuit (IC); and the other is that the antenna engineers have to design a matching circuit. Besides, when the antenna transmits and receives an electromagnetic wave signal, it must make the characteristic impedance of the RF IC of a radio station match with the characteristic impedance of the matching circuit, namely, to achieve the impedance matching between the RF IC and the matching circuit. Because the different countries have different requirements of communication frequency band, the RF engineers generally try to design all of frequency bands into a RF IC. When using specific frequency band, it can be switched by a switching circuit, so as to shorten the design time of the RF engineers and lower the cost.

However, for the antenna engineers, it is difficult to design the antenna as a multi-band antenna in a limited space, resulting in increasing the design time. Therefore, the antenna engineers generally apply the matching circuit to adjust the impedance of the antenna to achieve an optimization, so as to satisfy the specification and bandwidth defined by customers. But, If the physical conditions (such as the antenna space, the clear area, the peripheral element is too near, and etc.) are not enough, the application of the matching circuit will be limited.

Therefore, there is a need for providing a new method which can adjust antenna impedance to achieve the impedance matching.

### SUMMARY OF THE INVENTION

To overcome the problem of traditional technology, the present invention provides an antenna impedance matching method which can accurately adjust antenna impedance to achieve the impedance matching.

To achieve the above objective, the present invention provides an antenna impedance matching method, adjusting an impedance of an antenna to match an impedance of a radio frequency (RF) integrated circuit (IC), and comprising the following steps of: (1) providing an antenna matching IC; (2) obtaining a used frequency band of the RF IC, so as to obtain a frequency band signal; and (3) adjusting an impedance of the matching IC according to the band signal, so that the antenna achieves impedance matching.

In one embodiment of the present invention, the step (3) is embodied as: combining an inherent impedance of the matching IC to obtain the impedance matching according to a main resonance frequency of the antenna or the second, third, forth or up to Nth harmonic waves produced by a resonance.

In one embodiment of the present invention, the matching IC is integrated by a plurality of matching circuits with different frequency bands, and in the step (3), a switching circuit is provided, and the impedance of the matching IC is switched according to the switching circuit, so that the antenna achieves impedance matching.

In one embodiment of the present invention, the plurality of matching circuits comprise: a matching circuit of frequency band of GSM 850, a matching circuit of frequency band of GSM 900, a matching circuit of frequency band of DCS 1800, a matching circuit of frequency band of PCS 1900, and a matching circuit of frequency band of WCDMA 2100.

In one embodiment of the present invention, the antenna impedance matching method as claimed in claim 1, wherein the matching IC is a PI-type circuit which comprises a variable capacitor and a variable inductance; and in the step (3), a variable capacitor/inductance controller is provided, and the capacitor value of the variable capacitor and the inductance value of the variable inductance are controlled according to the variable capacitor/inductance controller, so that the antenna achieves impedance matching.

As described above, the present invention uses the matching IC to instead of a traditional matching circuit, and according to the band signal of the RF IC to adjust and match the impedance of the IC, so as to change the resonance and impedance of the antenna, and to achieve the impedance matching.

### BRIEF DESCRIPTION OF THE DRAWINGS

The present invention will be apparent to those skilled in the art by reading the following description of a preferred embodiment of the present invention, with reference to the attached drawings, in which:

FIG. 1 is a flowchart showing an antenna impedance matching method according to a first preferred embodiment of the present invention;

FIG. 2 is a structural block diagram according to a second preferred embodiment of the present invention; and

FIG. 3 is a structural block diagram according to a third preferred embodiment of the present invention;

### DETAILED DESCRIPTION OF THE PREFERRED EMBODIMENT

The foregoing objects, features and advantages adopted by the present invention can be best understood by referring to the following detailed description of the preferred embodiments and the accompanying drawings.

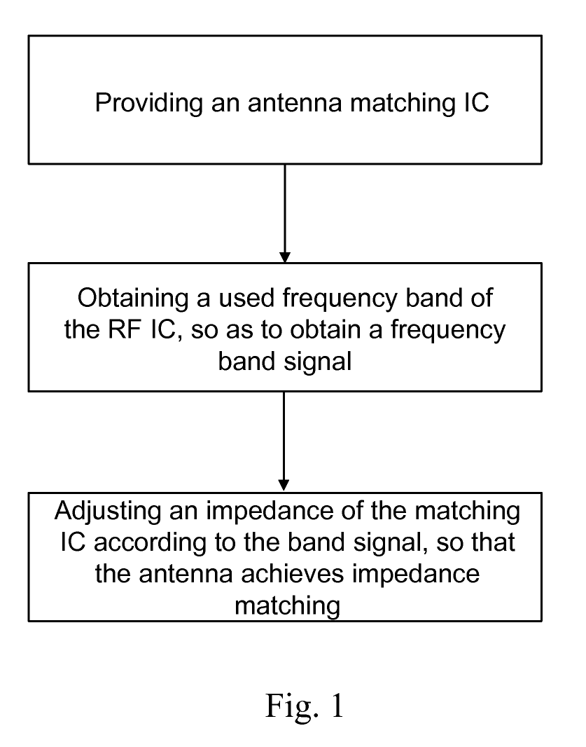

Referring now to FIG. 1, an antenna impedance matching method according to the present invention is used for adjusting an impedance of an antenna to match an impedance of a radio frequency (RF) integrated circuit (IC). The method comprises the following steps: (1) providing an antenna matching IC; (2) obtaining a used frequency band of the RF IC, so as to obtain a frequency band signal; (3) adjusting an impedance of the matching IC according to the band signal, so that the antenna achieves impedance matching.

In a first preferred embodiment of the present invention, the step (3) comprises: combining an inherent impedance of the matching IC to obtain the impedance matching according to a main resonance frequency of the antenna or the second, third, forth or up to Nth harmonic waves produced by a resonance. For example, the antenna 200 is set on a resonance of GSM 850, when the RF IC switches to GSM 900, because the main frequency of GSM 850 is close to the main frequency of GSM 900, the impedance matching can be achieved by using the main frequency of GSM 850 cooperating with the matching IC, so that the characteristic impedance of the antenna 200 can be equal to the characteristic impedance of the RF IC; when the RF IC switches to GSM 1800, because the second harmonic wave of GSM 850 is close to GSM 1800, the impedance matching can be achieved by using the second harmonic wave of GSM 850 cooperating with the matching IC, so that the characteristic impedance of the antenna 200 can be equal to the characteristic impedance of the RF IC.

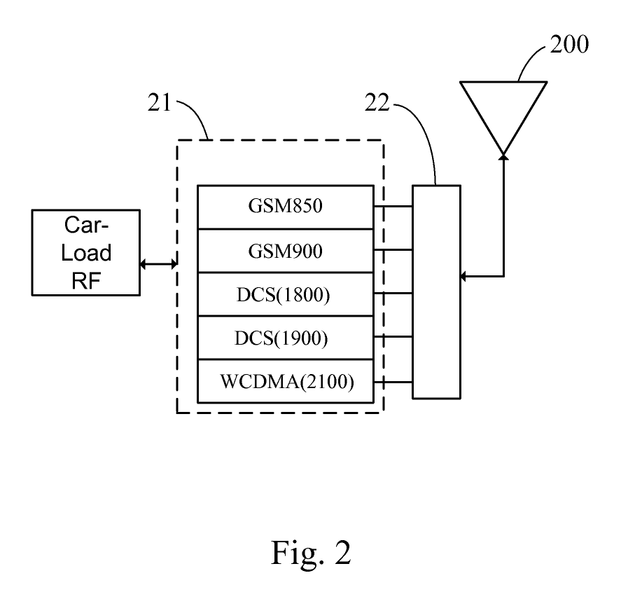

Referring now to FIG. 2, in a second preferred embodiment of the present invention, the matching IC is integrated by a plurality of matching circuits with different frequency bands. In the step (3), a switching circuit 22 is provided, and the impedance of the matching IC 21 is switched according to the switching circuit 22, so that the antenna 200 achieves impedance matching. Moreover, the plurality of matching circuits comprise: a matching circuit of frequency band of GSM 850, a matching circuit of frequency band of GSM 900, a matching circuit of frequency band of DCS 1800, a matching circuit of frequency band of PCS 1900, and a matching circuit of frequency band of WCDMA 2100.

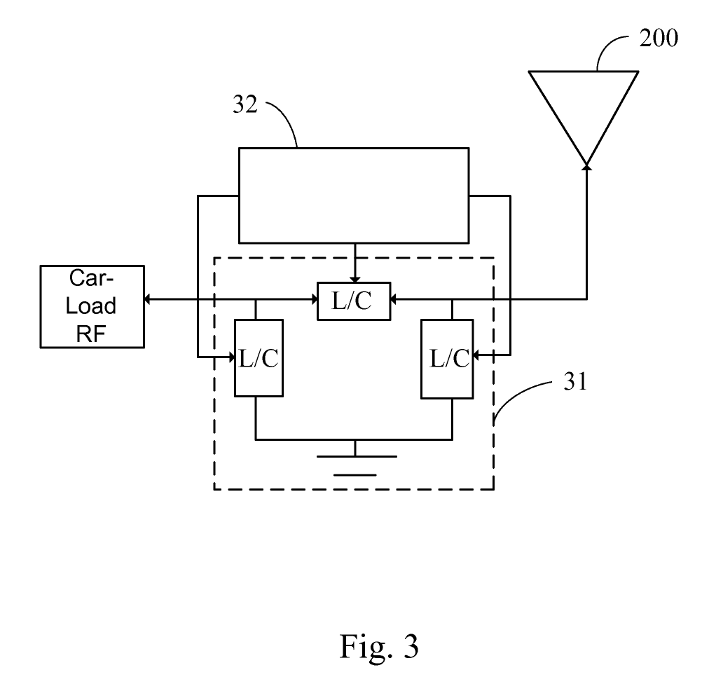

Referring now to FIG. 3, in a third preferred embodiment of the present invention, the matching IC 31 is a PI-type circuit which comprises a variable capacitor and a variable inductance (L/C). In the step (3), a variable capacitor/inductance controller 32 is provided, and the capacitor value of the variable capacitor and the inductance value of the variable inductance are controlled according to the variable capacitor/inductance controller 32, so that the antenna achieves impedance matching.

Referring now to FIGS. 1 to 3, the present invention processes the antenna impedance matching is as follows: firstly, by using a receiving unit, to obtain a used frequency band of the RF IC, so as to obtain a frequency band signal; then, by using a central controlling unit, to adjust the impedance of the matching IC until that the antenna achieves impedance matching.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An antenna impedance matching method, adjusting an impedance of an antenna to match an impedance of a radio frequency (RF) integrated circuit (IC), and comprising the following steps of:
(1) providing an antenna matching IC;
(2) obtaining a used frequency band of the RF IC, so as to obtain a frequency band signal; and
(3) adjusting an impedance of the matching IC according to the band signal, so that the antenna achieves impedance matching.

2. The antenna impedance matching method as claimed in claim 1, wherein the step (3) further comprises: combining an inherent impedance of the matching IC to obtain the impedance matching according to a main resonance frequency of the antenna or the second, third, forth or up to Nth harmonic waves produced by a resonance, wherein N is an integer.

3. The antenna impedance matching method as claimed in claim 1, wherein the matching IC is integrated by a plurality of matching circuits with different frequency bands, and in the step (3), a switching circuit is provided, and the impedance of the matching IC is switched according to the switching circuit, so that the antenna achieves impedance matching.

4. The antenna impedance matching method as claimed in claim 3, wherein the plurality of matching circuits comprise: a matching circuit of frequency band of GSM 850, a matching circuit of frequency band of GSM 900, a matching circuit of frequency band of DCS 1800, a matching circuit of frequency band of PCS 1900, and a matching circuit of frequency band of WCDMA 2100.

5. The antenna impedance matching method as claimed in claim 1, wherein the matching IC is a PI-type circuit which comprises a variable capacitor and a variable inductance; and in the step (3), a variable capacitor/inductance controller is provided, and the capacitor value of the variable capacitor and the inductance value of the variable inductance are controlled according to the variable capacitor/inductance controller, so that the antenna achieves impedance matching.
